(19) United States
(12) Patent Application Publication
(10) Pub. No.: US 2010/0315373 A1
(43) Pub. Date: Dec. 16, 2010

(54) SINGLE OR MULTITOUCH-CAPABLE TOUCHSCREENS OR TOUCHPADS COMPRISING AN ARRAY OF PRESSURE SENSORS AND THE PRODUCTION OF SUCH SENSORS

(76) Inventors: Andreas Steinhauser, Berlin (DE); Milosch Meriac, Berlin (DE)

Correspondence Address: OSHA LIANG L.L.P., TWO HOUSTON CENTER, 909 FANNIN, SUITE 3500, HOUSTON, TX, 77010, US

(21) Appl. No.: 12/739,695

(22) PCT Filed: Oct. 27, 2008
(86) PCT No.: PCT/EP2008/064547

§ 371 Date: Jun. 25, 2010

(30) Foreign Application Priority Data
Oct. 26, 2007 (DE) 102007052008.7

(51) Int. Cl. G06F 3/041

(52) U.S. Cl. 345/174

(57) ABSTRACT

A multitouch-capable touchscreen is realized in that a large number of pressure sensors are attached under a flexible surface and thus both the pressure distribution and also the deformation of the surface is measured. Local pressure maxima occur due to the flexibility of the surface material with associated deformation on contact. As several local pressure maxima can exist, it is thus also possible to identify a plurality of contacts simultaneously. It is possible from the strength of pressure and pressure distribution to determine the force that is used for pressing such that this information can also be used in the user interface. Such sensors can be produced very efficiently and inexpensively by printing an ink that changes its resistance under pressure onto PCB tracks designed as sensor surfaces. The PCB tracks and the sensor surfaces can also be printed out using an ink with as low a resistance as possible.

The invention relates to a touchscreen or touchpad that determines the position of the contact.

### BACKGROUND

Currently there are several methods of interaction with machines or computers, e.g. mouse, keyboard, touchscreen, touchpad and various sensors.

Touchscreen technology in particular is becoming increasingly popular as here direct interaction with the device is possible with immediate feedback via the screen. In addition, with mobile devices in particular, the space-saving is relevant as display and touch interface combined take up less room than display plus, for example, a keyboard. However, even touchpads, that is to say touch-sensitive surfaces, are now the most common replacement for a mouse, e.g. with notebooks.

With the invention of what are referred to as multitouch-capable touch devices (touchscreen or touchpad) with which more than one finger or stylus or other objects can be detected, a completely new interaction becomes possible, e.g. with a plurality of people simultaneously on one display. It is additionally possible to implement more intuitive interfaces that can be operated with a plurality of fingers.

These methods are either difficult or impossible to miniaturise or are very expensive. So far an inexpensive, sturdy and easily miniaturisable solution is lacking.

Multitouch-capable two-dimensional input devices are now usually implemented via imaging methods or via transparent, capacitive sensor arrays above the display. The use of inductive methods is also conceivable.

With the imaging methods an infrared camera “looks at” a semi-transparent projection surface made of glass or acrylic. The computer image to be depicted is projected onto this projection surface from below by means of a beamer. At the same time the pane is illuminated from the side using infrared light. If one or a plurality of fingers now touch the projection surface, the refractive index of the glass changes at this point and one sees the finger or fingers (and only these) as points in the image of the infrared camera. One can now localise these points by means of image recognition and calculate the position as a result. At present such imaging methods cannot be produced flat enough to be used in mobile devices.

There are, however, various experiments in which arrays of infrared LEDs and sensors are attached behind a TFT display in order to detect the reflection of the infrared light of the LEDs on the finger.

However, by using the LEDs the energy consumption is comparatively high with the result that the method is hardly suitable for use in mobile devices. On top of that it is also sensitive to external infrared radiation, e.g. sunlight. There are also methods which integrate the sensors in the display's manufacturing process. Basically, however, these are dependent on the display technology and are very specific. On no account can they be integrated subsequently. In the case of capacitive multitouch interfaces, the change in the capacitance of one or a plurality of sensors is measured on the approach of a finger or other dielectric. It is then possible to calculate the position of one or a plurality of fingers by interpolating the signals of various sensors disposed as an array. Capacitive sensor technology is susceptible to interference from stray radiation and furthermore cannot penetrate a display which is common at present. Therefore the sensors must be manufactured transparently on an indium tin oxide base and disposed above the display. Such interfaces are very expensive as indium is one of the rarest elements on earth. Furthermore, they are not perfectly transparent with the result that readability of the screen suffers and any reflective effects can act disruptively on the interface.

Inductive methods are based on the highly disruptive aspect that they can only function with special styluses that contain electronic components.

Touchscreen or touchpad interfaces in which only one finger can be detected are currently implemented in the most different ways.

Among other things there are methods to determine the finger position based on pressure sensors that are attached on the corners of the display and that calculate the position from the different pressure conditions at the sensors according to the lever rule. These cannot be used, however, to detect more than one finger or stylus. In addition, the surface may not be flexible or must by reinforced if necessary against bending otherwise interpolation cannot be performed with sufficient accuracy.

There also exist pressure sensor arrays that can be used to measure the different pressure conditions on a surface as precisely as possible, e.g. for medical purposes (pressure conditions on the soles of feet when standing or walking) or in instrument measuring technology, for example, to measure the different pressures of the entire surface of a brake pad on a brake disk.

The examples referred to may be inferred from the following documents DE102006031376 DE19632866 EP0684578 EP0754370 EP0932117 EP1621989 EP1745356 EP1853991 US2005083310 U.S. Pat. No. 5,945,980 U.S. Pat. No. 6,188,391 U.S. Pat. No. 7,030,860 WO04114105 WO2004044723.

### SUMMARY OF THE INVENTION

The object of the invention referred to in claim 1 is to manufacture, very efficiently and inexpensively, a single or multitouch-capable display or touchpad that is both sturdy and insensitive to interference and that can also be miniaturised easily and used in mobile devices.

This object is achieved by a device with the features of the independent claims. In particular, the object is achieved by means of pressure sensors (3) that are disposed as a two-dimensional array on a base (1) and are provided with signal cables (2) such that each sensor can be evaluated individually. Placed on this array such that every pressure sensor touches the display or the surface is a display (4) that is as thin and therefore as flexible as possible for use as a touchscreen, or a surface of flexible material (4) (e.g. PVC, acrylic through to paper, textiles or similar) for use as a touchpad.

As modern displays are generally very thin, they have a certain amount of elasticity. When being used as a touchpad (without display) it is possible to select the elasticity of the surface due to the choice of the material itself.

### DESCRIPTION OF THE FIGURES

The Figures and the following description of them are used as an exemplary embodiment for better understanding of the invention. In detail

Fig. A shows the perspective layered construction of a display having a sensor layer and a presentation layer;

Figs. B-B(1)-(2) show the layered construction from the side in various degrees of detail;

Fig. C shows the schematic construction of one of the many sensors from above;

Fig. D-D shows the sensor from C in a lateral view;

Fig. E-E shows a lateral view of an embodiment having a sensor that changes its resistance as a result of pressure;

Fig. F shows a view from above onto a pressure-sensitive ink that has PCB tracks already interlocked with each other at those points where pressure sensors are supposed to occur.

Fig. G shows a multi-layer sensor having a lattice-shaped grid whereby applied at the nodal points of the grid is a view that alters the resistance as a function of pressure such that the upper and lower PCB tracks bring about a short-circuit;

Fig. H shows a lateral view of Fig. G.

### DETAILED DESCRIPTION

The Figures referred to above will be explained in detail in the following.

Fig. A shows a perspective layered construction of the invention having a sensor layer and a display layer.

If a finger or other object (F1) touches the display or the surface (4), this pressure is transferred variably to the underlying sensor (R1 and R2 in Fig. B-B (1))according to the lever rule. By applying the lever rule, paths L1 and L2 can already be clearly determined for all the sensors and therefore the position of the finger on the surface even when using only three pressure sensors, though it is not possible in this way to differentiate a second contact.

However, as in addition the display or surface is slightly elastic, the surface is easily and reversibly deformed at the point of contact (Fig. B-B (2)). This deformation leads to the sensors close to the contact being loaded more heavily and those further away more lightly than would be expected according to the lever rule. This leads to a local maximum of the sensor values in the immediate vicinity of the contact point.

If then a second contact (F2) takes place at an adequate distance, this pressure also acts according to the lever rule though in addition a further local maximum occurs due to the deformation of the surface. The adequate distance of the contacts is defined via the spacing of the sensors, the measuring accuracy of the sensors and the elasticity of the surface.

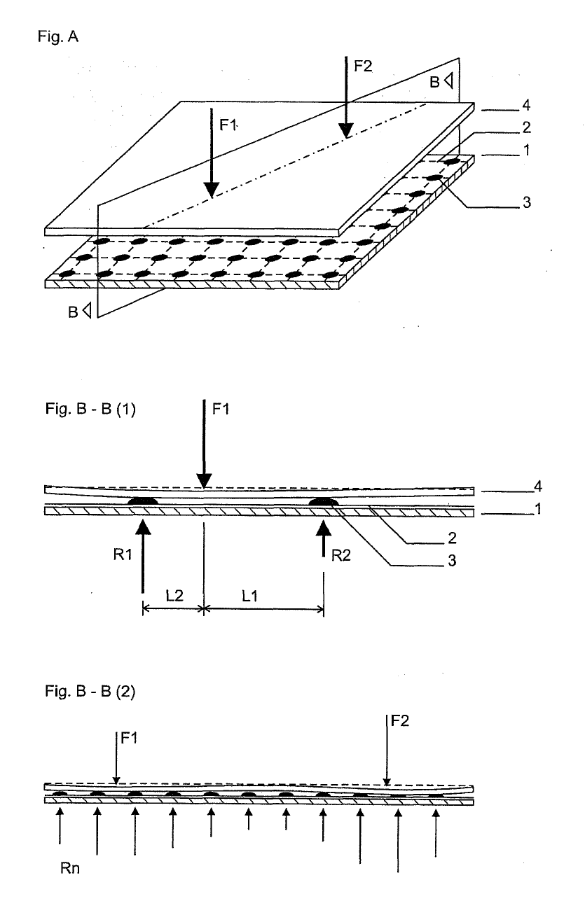

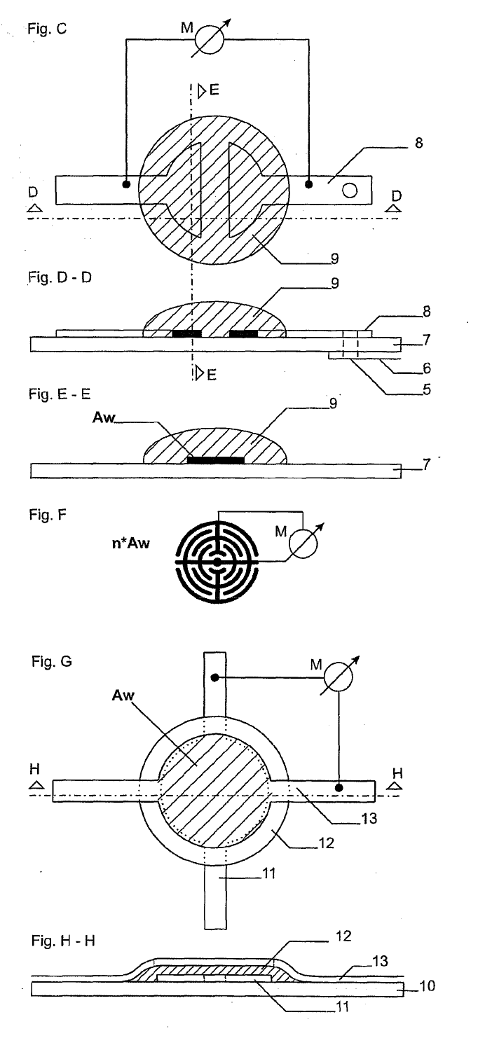

In particular, pressure sensors for such an array may be manufactured by printing a material that changes its resistance under pressure (9) onto a substrate (7) with corresponding PCB tracks (5, 6 and 8) in a printing process. A standard process in the manufacture of printed circuit boards in which a solder paste is usually applied to the printed circuit board through a stencil can be used very efficiently for this. The invention is not, however, restricted to this process. There is a series of further processes that bring about the same success. In the same way it is then possible to print the pressure-sensitive ink onto the PCB already prepared for this, the PCB having tracks already interlocked with each other (FIG. 6) at those points where pressure sensors are supposed to occur in order to measure the ink's resistance. In the same way it is then possible to apply a further layer of a synthetic material to increase the thickness of the sensors. As a result the gap between the surface or the display to the sensor field increases somewhat so that contact with the display can also be guaranteed and deformation of the surface is possible without said surface touching the base (7).

This contact can also be prevented by attaching the sensors in an appropriate shape (square, hexagonal, etc.) so closely next to one another that the ink (9) itself forms the surface. Then an additional surface is not necessary when used as a touchpad. Using this process, production of the pressure sensors can be integrated extremely well and extremely inexpensively into the manufacturing process of the evaluating electronics.

The sensors can also be produced completely within the printing process by printing the PCB tracks (11 and 13) too onto a base in an ordinary printing process using a substance or “ink” that has an unchanging and preferably the lowest possible electrical resistance.

Initially an array of sensor fields (11) is printed with associated PCB tracks onto a base (10). The ink (12) with the resistance that changes under pressure is then printed on the sensor surfaces (11).

In a further printing process the corresponding PCB tracks are applied to the sensor surfaces (13). No short-circuit can occur between the top and bottom sensor layer as the ink (12) completely encloses the sensor surface (11). The resistance can then be measured via the active surface (Aw).

In this way it is possible to apply sensors to virtually any base. If the base is electrically conductive, then an insulating layer must be applied first of all. This can also take place during the printing process or by some other appropriate method. If necessary an insulating layer must also be applied in this way above the sensor and PCB tracks such that no electrical contact can be made with the object making contact.

The described embodiments do not intend to limit the scope of the invention. It is intended that the following claims define the invention and its scope of protection without being limited by the described embodiments.

1. Touchscreen with a display, wherein the position of the contact of a finger or other object on a flexible surface is determined by an array of pressure sensors that are located not only on the edge of the surface but that being distributed over the entire surface measure the pressure acting on the relevant point, wherein the deformation sensors are attached directly to the rear or are printed to the rear of the flexible display.

2. Touchscreen according to claim 1, wherein resistive pressure sensors are used as pressure sensors.

3. Touchscreen according to claim 2, wherein resistive pressure sensors based on a material which changes its electrical resistance under pressure are used as pressure sensors.

4. Touchscreen according to claim 3, wherein the pressure sensors are produced in a printing process in which the material which changes its electrical resistance under pressure is printed onto a base that is already provided with appropriate PCB tracks (printed circuit board).

5. Touchscreen according to claim 4, wherein the PCB tracks are also printed onto a base in a printing process.

6. Touchscreen or touchpad according to claim 4, characterised in that wherein interlocked PCB tracks are used as sensor surfaces to reduce the resistance to be measured and therefore the susceptibility.

7. Touchscreen according to claim 3, wherein the intermediate spaces are provided with conductive surfaces that are joined to the electrical ground of the resistance measuring electronics in order to minimize minimise external interference.

8. Touchscreen according to claim 4, wherein the sensors are printed on flexible or rigid, non-conductive bases, in particular plastics, textiles, paper or cardboard.

9. Touchscreen according to claim 4, wherein the sensors are printed on flexible or rigid conductive bases, in particular conductive plastics, textiles, metals and metal foils by first of all applying an electrically insulating layer.

10. Touchscreen according to claim 3, wherein an insulating layer is applied on the sensor array as the top layer in order to protect the sensors electrically and mechanically.

11. Touchscreen to claim 3, wherein the material which changes its electrical resistance under pressure is used over the entire surface such that application of an insulating layer applied on the sensor array as the top layer in order to protect the sensors electrically and mechanically becomes unnecessary.

12. Touchscreen according to claim 1, wherein capacitive pressure sensors are used as pressure sensors.

13. Touchscreen according to claim 1, wherein sensors which measure the deformation of the surface are used as sensors.

14. Touchscreen according to claim 13, wherein deformation sensors which measure the sensor's distance to the surface are used as sensors.

15. (canceled)

16. Touchscreen according to claim 1, wherein the exact position of the contact is determined by being able to interpolate the position from the pressure distribution of the sensors according to the lever rule and with additional knowledge of the surface's flexibility.

17. Touchscreen according to claim 1, wherein a local maximum of the sensors that are closest to the contact is evaluated due to the surface's flexibility.

18. Touchscreen according to claim 1, wherein further contacts can be differentiated because an additional local maximum is generated by each further contact as long as the further contact is made at an adequate distance, wherein the adequate distance of the contacts is defined via the spacing of the sensors, the measuring accuracy of the sensors and the elasticity of the surface.

19. (canceled)

20. Touchscreen according to claim 1, wherein the display is a rollable, creasable, foldable or bendable display.

21. Touchscreen according to claim 20, wherein the pressure sensors are applied directly on the flexible display in the form of deformation sensors, in particular also by means of the printing processes.

22. Touchscreen according to claim 20, wherein the display is a TFT display, an OLED display, a plasma display, a bistable or omnistable display, e-ink or what is known as electronic paper, or an LCD display.

23. (canceled)
